(19) United States
(12) Patent Application Publication
(10) Pub. No.: US 2005/0026560 A1
(43) Pub. Date: Feb. 3, 2005

(54) Audio communications system including wireless microphone and wireless speaker

(75) Inventors: Marcial S. Villaverde, Mount Prospect, IL (US); Tony Vassos, Chicago, IL (US); Kerry Hartman, Woodbridge, VA (US)

Correspondence Address: PILLSBURY WINTHROP, LLP, P.O. BOX 10500, MCLEAN, VA, 22102, US

(73) Assignee: FELLOWES INC., Itasca, IL (US)

(21) Appl. No.: 10/886,715

(22) Filed: Jul. 9, 2004

Related U.S. Application Data
(60) Provisional application No. 60/490,257, filed on Jul. 28, 2003.

(51) Int. Cl. H04H 7/00

(52) U.S. Cl. 455/3.06; 455/3.05

(57) ABSTRACT

An audio communications system is configured to support a two-way voice communication with a telephone. The system includes a microphone configured to transmit a first wireless signal that includes the outgoing portion of the two-way voice communication. The system also includes a speaker configured to receive a second wireless signal that includes the incoming portion of the two-way voice communication. The system is configured such that transmission of the first wireless signal and the reception of the second wireless signal may occur at separate locations.

### CROSS-REFERENCE TO RELATED APPLICATION

This application is based on U.S. Provisional Application No. 60/490,257 filed Jul. 28, 2003, the entire contents of which is hereby incorporated by reference.

### BACKGROUND

1. Field of the Invention

The present invention relates to an audio communications system. More specifically, the present invention relates to an audio communications system configured to wirelessly communicate with a telephone.

2. Background Information

Various audio communication devices have been developed to assist cellular phone users. For example, one such device is a “hands-free” system. This system comprises a microphone/speaker combination which is connected to a cellular phone with an adapter cord. The combination is worn on a user's head and allows the user to engage in voice calls without having to hold the cellular phone. In this manner the user is able to perform other tasks while on the telephone since the user's hands are not occupied. One such task may be operating a vehicle. As may be understood, however, the wired connection between the microphone/speaker combination and the cellular phone is inconvenient and may interfere with other tasks that the user performs. Additionally, users may be uncomfortable when wearing the device.

A variant of the hands-free system is a device that includes a microphone and a speaker that are attached to an automobile cigarette lighter adapter. Such a device may free the user from having to be connected to the telephone by a wire. However, the microphone and speaker of such a unit are physically attached to one another. For example, the microphone and speaker may be enclosed within the same housing, or the microphone may be disposed within a boom coupled to the housing enclosing the speaker. Such a device provides limited options of positioning the microphone and speaker relative to the user and to each other.

One alternative to the hands-free system is the in-vehicle system. This system is installed in the vehicle in a permanent fashion. The connections within the system do not interfere with the user since they are installed in the vehicle and generally hidden from the user. Additionally, the user is not required to wear any piece of the system since the microphone and speaker are integrated into the vehicle. However, this system requires installation into the vehicle, which typically needs to be performed by a professional, and may therefore be expensive. Additionally, the installation is permanent, and the system may not be easily removed from one vehicle and placed in another vehicle.

Another alternative is disclosed in U.S. Pat. No. 4,905,270. The '270 reference discloses a microphone which is built into the visor of a vehicle. The microphone receives a signal (the user's conversation) and outputs a frequency-modulated (FM) signal to a receiver. However, the FM signal may be easily intercepted by a third party. Therefore, this device may be undesirable for wirelessly communicating with a cellular phone.

### SUMMARY

A wireless communications system according to one embodiment of the invention is configured to support a two-way voice communication with a telephone. The system includes a microphone configured to receive a first audible signal and to transmit a first wireless signal from a first location. The first wireless signal includes the outgoing portion of the two-way voice communication, which is based on the first audible signal.

The system also includes a speaker configured to receive a second wireless signal at a second location, which is separated from the first location. The second wireless signal includes the incoming portion of the two-way voice communication, and the speaker is configured to produce a second audible signal based on the incoming portion.

Several different arrangements of this system are described, including different schemes of communication within the system and between the system and the telephone. Support for data transfer between an external data processing device and the telephone via the system is also described.

Other objects, features, and advantages of the present invention will become apparent from the following detailed description, the accompanying drawings, and the appended claims.

### BRIEF DESCRIPTION OF THE DRAWINGS

Embodiments of the invention will now be described, by way of example only, with reference to the accompanying schematic drawings in which:

FIG. 1 is a block diagram of a system 100 according to an embodiment of the invention;

FIG. 2 is a block diagram of an implementation 110 of system 100;

FIG. 3 is a block diagram of an implementation 120 of system 100;

FIG. 4 is a block diagram of an implementation 130 of system 100;

FIG. 5 is a block diagram showing implementations 212, 222, and 232 of microphone 200;

FIG. 6 is a block diagram showing implementations 282 and 284 of input audio processor 280;

FIG. 7 is a block diagram showing implementations 312, 322, and 332 of speaker 300;

FIG. 8 is a block diagram showing implementations 382 and 384 of output audio processor 380;

FIG. 9 shows a timing diagram for a SCO scheme as described in the Bluetooth specification;

FIG. 10 shows a timing diagram for a SCORT scheme proposed for use with Bluetooth-capable devices; and

FIG. 11 shows a block diagram of an implementation 140 of system 100.

### DETAILED DESCRIPTION

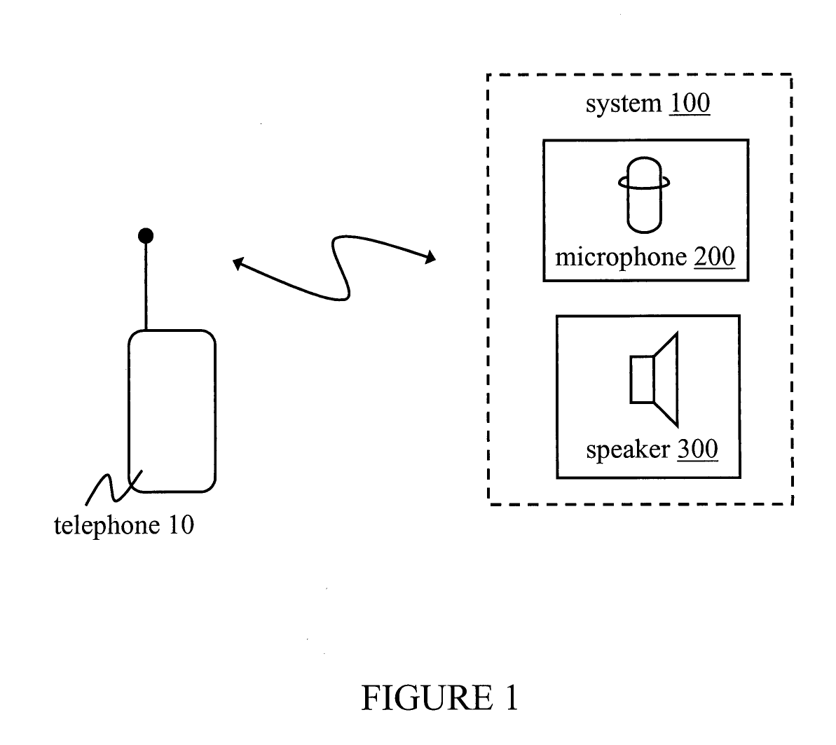

FIG. 1 shows a block diagram of a wireless communications system 100 according to an embodiment of the invention. As illustrated in this figure, system 100 is configured to support a wireless two-way communications link with a suitable telephone 10.

Telephone 10 is a device (such as a cellular telephone, or a portable digital assistant or other portable device that includes cellular telephony capabilities) which is configured to originate or terminate a telephone call. Telephone 10 is also capable of communicating wirelessly (e.g. via modulation of one or more optical or radio carriers) with other devices. For example, telephone 10 may be compliant with one or more Bluetooth profiles (as described in specifications available e.g. at www.bluetooth.org) and/or one or more IEEE 802.11 standards (e.g. 802.11a, 802.11b, 802.11g, as described in standards documents available at e.g. www.ieee.org).

System 100 includes a microphone 200 configured to receive one portion of a two-way voice communication as audible sound and to transmit a wireless signal based on the received audible sound. System 100 also includes a speaker 300 configured to receive the other portion of the two-way voice communication as a wireless signal and to produce an audible signal based on the other portion.

Although they are both components of system 100, microphone 200 and speaker 300 need not be electrically or even physically connected. For example, system 100 may be implemented such that each one of microphone 200 and speaker 300 is completely physically separate from the other, with either one being locatable and movable independently of the other. Subject to possible constraints relating to the nature and range of the communications between microphone 200, speaker 300, and/or telephone 10, the components of system 100 may be moved relative to each other even during operation of system 100.

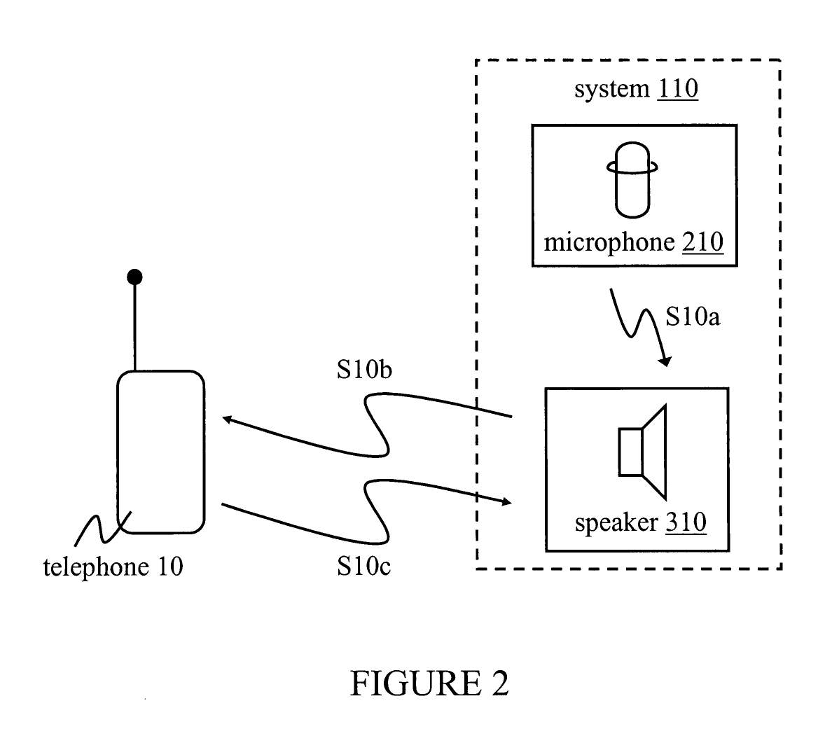

FIGS. 2-4 show examples of some of the different ways in which system 100 with its component devices 200 and 300 may be implemented. FIG. 2 shows an example of one implementation 110 of system 100 that includes implementations 210 and 310 of microphone 200 and speaker 300, respectively. In system 110, microphone 210 receives one portion of a two-way voice communication as audible sound and transmits a wireless signal S10a that is based on the received audible sound. Speaker 310 receives signal S10a and transmits a wireless signal S10b that contains at least the sound information carried by signal S10a. Speaker 310 also receives a wireless signal S10c that is transmitted by telephone 10, and speaker 310 produces an audible signal based on audio information carried by signal S10c. In system 110, speaker 310 supports both parts of the two-way communications link with telephone 10.

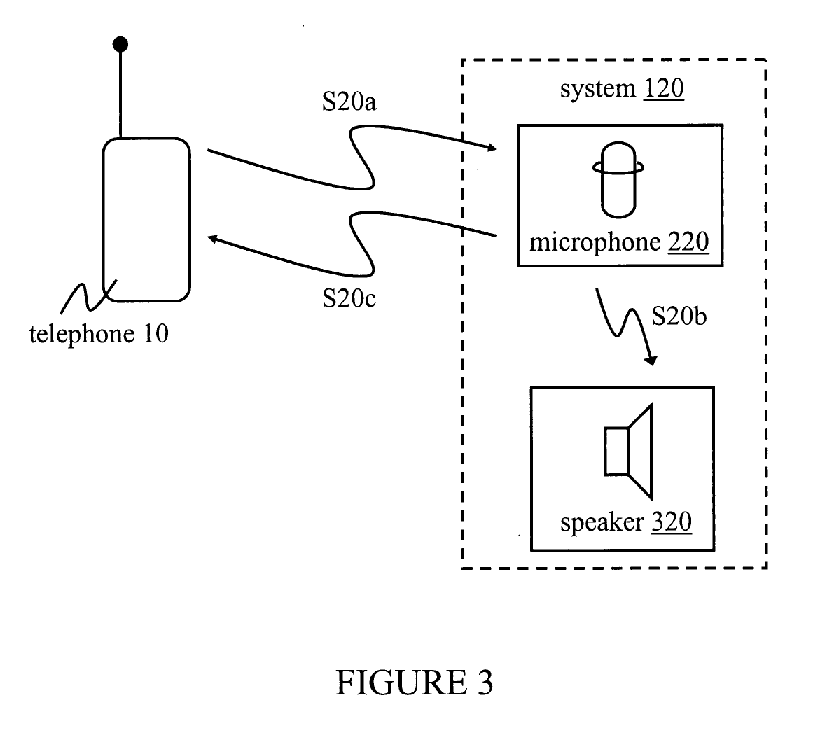

FIG. 3 shows an example of another implementation 120 of system 100 that includes implementations 220 and 320 of microphone 200 and speaker 300, respectively. In system S120, microphone 220 receives a wireless signal S20a from telephone 10 that includes audio information, and microphone 220 transmits a wireless signal S20b that contains at least the audio information carried by signal S20a. Speaker 320 receives signal S20b and produces sound based on that audio information. Microphone 220 also receives audible sound and transmits a wireless signal S20c based on that sound. In system 120, microphone 220 supports both parts of the two-way communications link with telephone 10.

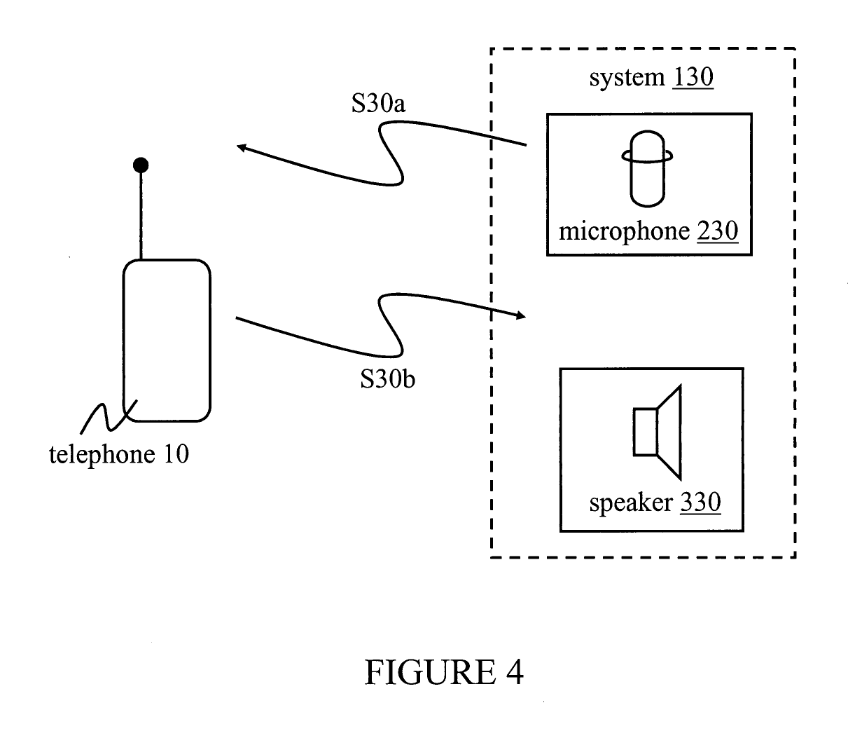

FIG. 4 shows an example of yet another implementation 130 of system 100 that includes implementations 230 and 330 of microphone 200 and speaker 300, respectively. In system 130, microphone 230 receives one portion of a two-way voice communication as audible sound and transmits a wireless signal S30a that is based on the received audible sound. Like microphone 220 of system 120, microphone 230 receives a wireless signal from telephone 10 (signal S30b) that includes audio information, and microphone 230 supports both parts of the two-way communications link with telephone 10. In system 130, however, speaker 330 also receives signal S30b, and speaker 330 produces sound based on audio information in signal S30b.

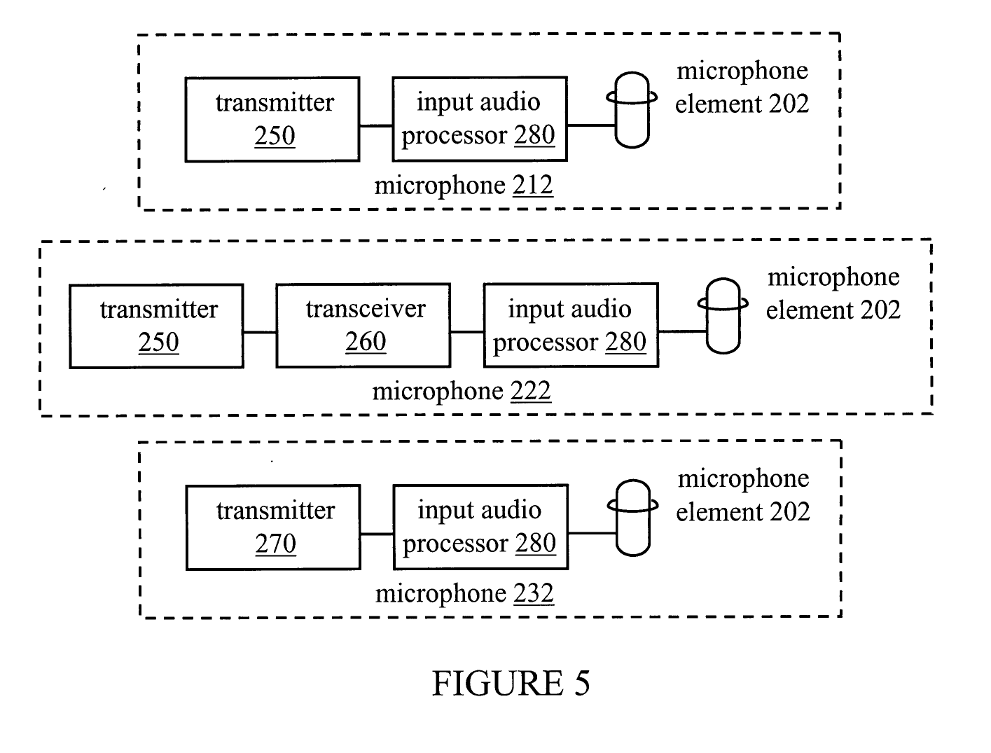

FIG. 5 shows implementations 212, 222, and 232 of microphones 210, 220, and 230, respectively. Each of these microphones includes a microphone element 202, which may be an electret condenser microphone (ECM) element. Alternatively, microphone element 202 may be a dynamic, crystal, or other type of condenser microphone element, or another transducer suitable for converting received sound into electrical variations.

Microphone element 202 may reside in the same housing as the other components of microphone 212/222/232, or element 202 may be separate from at least the transmitter or transceiver of microphone 212/222/232. An implementation of microphone 200 may also include a jack or other connector suitable for receiving audio-frequency input from another device.

Microphone 200 may be implemented to include a device to facilitate mounting the microphone (or at least microphone element 202) to an external location. For example, microphone 200 may be provided with a clip or a fixative surface (e.g. adhesive or velcro) for such purpose. In one such application, it may be desired to removably mount microphone 200 on a suitable portion of an automobile (e.g. a sun visor, upon which microphone 200 or microphone element 202 may be positioned in close proximity to the speaker's mouth). Alternatively, microphone 200 or microphone element 202 may be fashioned to be secured to or otherwise wearable by a user (e.g. may include a lapel clip, or a boom or other arrangement designed to be worn over the ear).

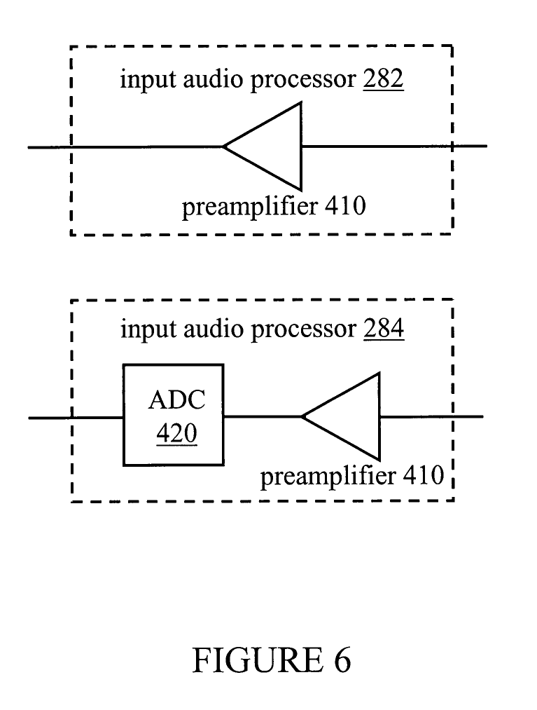

Each of the microphones 212, 222, and 232 shown schematically in FIG. 5 also includes an input audio processor 280. FIG. 6 shows two alternate implementations 282 and 284 of input audio processor 280. Each implementation includes a preamplifier 410 which provides suitable gain (and possibly impedance matching) to operably couple microphone element 202 to other signal processing or transmission circuitry. In a case where microphone element 202 is an ECM, preamplifier 410 may also provide a suitable bias voltage.

Further implementations of input audio processor 280 may include a voice recognition engine configured to receive voice commands from a user and to output corresponding information signals to control functions of system 100 and/or for transmission to telephone 10. An implementation of microphone 200 may also include a mute button to temporarily disable transmission of a signal received from microphone element 202; such an implementation may also include a corresponding indicator (e.g. a light-emitting diode) to indicate activation of the mute function.

It may be desirable for microphone 200 to convert a received analog signal into a digital signal before transmission. For example, transmission by a digital modulation technique may provide greater security against eavesdropping, greater immunity to noise, and/or a lower energy cost than transmission by analog modulation. As shown in FIG. 6, implementation 284 of input audio processor 280 includes an analog-to-digital converter (ADC) 420. Implementations of input audio processor 280 may also perform other signal processing tasks or functions such as filtering, equalization, gain control, noise cancellation, and/or echo cancellation.

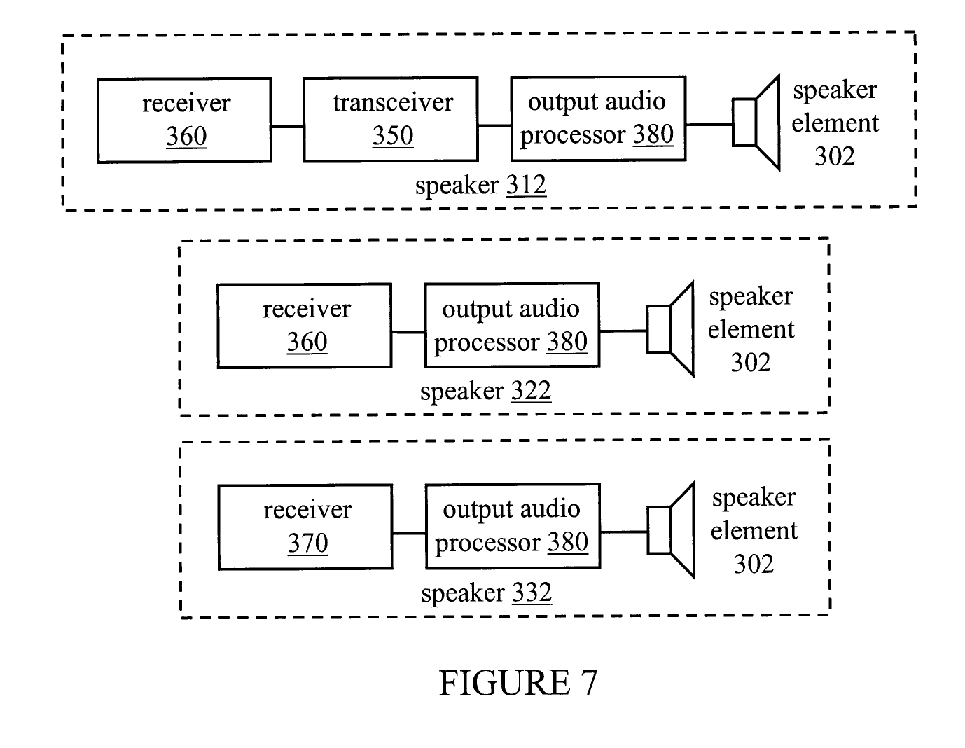

FIG. 7 shows implementations 312, 322, 332 of speakers 310, 320, and 330, respectively. Each of these speakers includes a speaker element 302, which may be a piezoelectric element or a diaphragm (moved e.g. by a voice coil or electrostatically). Alternatively, speaker element 302 may be another transducer configured to convert electrical signals to audible vibrations.

Speaker element 302 may reside in the same housing as the other components of speaker 312/322/332, or speaker element 302 may be separate from the receiver or transceiver of speaker 312/322/332. An implementation of speaker 300 may also include a jack or other connector suitable for outputting audio information in analog or digital form. For example, such a jack or connector may support an optical or wired connection from speaker 300 to another device for sound reproduction (e.g. an automobile sound system).

Speaker 300 may be implemented to include a device to facilitate mounting the speaker (or at least speaker element 302) to an external location. For example, speaker 300 may be provided with a clip or a fixative surface (e.g. adhesive or velcro) for such purpose. In one such application it may be desirable to removably mount speaker 300 on a suitable portion of an automobile (such as a headrest, upon which speaker 300 or speaker element 302 may be positioned in close proximity to the user's ear). Alternatively, speaker 300 or speaker element 302 may be fashioned to be secured to or otherwise wearable by a user (e.g. as an earbud or earclip).

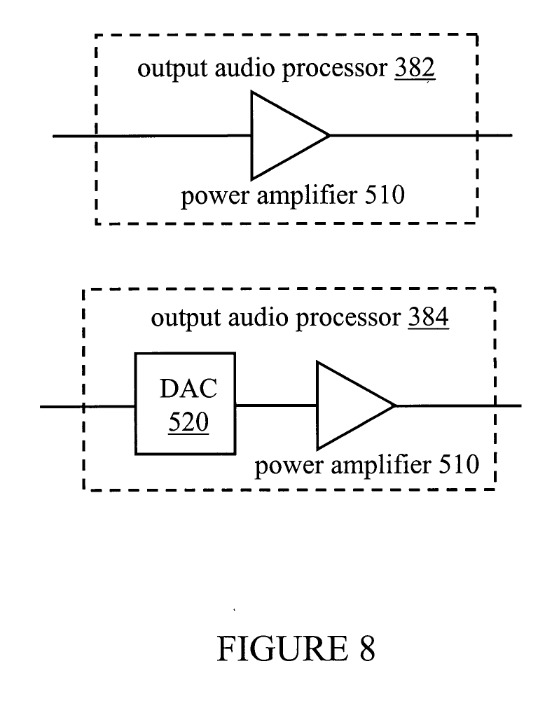

Each of the speakers 312, 322, and 332 shown schematically in FIG. 7 also includes an output audio processor 380. FIG. 8 shows two alternate implementations 382 and 384 of output audio processor 380. Each of these implementations includes a power amplifier 510 which provides suitable gain (and possibly impedance matching) to drive speaker element 302. Output audio processor 380 may also include a volume control operable by the user to control the volume of sound produced by speaker 312/322/332. Implementations of output audio processor 380 may also perform other signal processing tasks or functions such as filtering, equalization, gain control, and/or noise cancellation.

It may be desirable for speaker 300 to convert a received digital signal into an analog signal before reproduction. For example, it may be desirable for speaker 300 to receive audio information via a signal that is compatible with a digital protocol (e.g. as discussed below). As shown in FIG. 8, implementation 384 of output audio processor 380 includes a digital-to-analog converter (DAC) 520.

As shown in FIG. 1, system 100 is configured to support a wireless two-way communications link with telephone 10. Systems 110 and 120 each include a unit that supports a two-way wireless communications link with telephone 10. In system 110, for example, speaker 310 supports the two-way wireless communications link with telephone 10, while in system 120, microphone 220 supports this two-way link. FIGS. 5 and 7 show block diagrams of implementations of microphone 220 and speaker 310, respectively, that include a transceiver (260 and 350, respectively) which supports the two-way wireless communications link with telephone 10. FIGS. 5 and 7 also show block diagrams of implementations of microphone 230 and speaker 330, respectively, that include elements (transmitter 270 and receiver 370, respectively) which each support a portion of the two-way wireless communications link with telephone 10.

Each of microphone 200 and speaker 300 may be independently powered by one or more batteries. In a case where these batteries are rechargeable, one or both of microphone 200 and speaker 300 may include a socket or other connector adapted to receive a cable for temporary connection to an external power source (e.g. a wall outlet, an automobile cigarette lighter, or a computer port such as a Universal Serial Bus (USB) port, or a charging circuit configure to receive power from such a source). One or both of microphone 200 and speaker 300 may also include circuitry for controlling the charging of the batteries from the external source. Other sources that may be used to power each of microphone 200 and speaker 300 include capacitors having sufficiently high storage capacity (e.g. so-called “supercapacitors”) and fuel cells. One of microphone 200 and speaker 300 may also be configured to be connected to or even mounted on an automobile cigarette lighter during use.

The transmitters, receivers, and/or transceivers of system 100 may be equipped as appropriate with one or more emitters for emitting communications signals and/or detectors for receiving communications signals. For optical communications, such devices may include photoemitters such as light-emitting diodes (LEDs) and photodetectors such as photodiodes or phototransistors. A filter (made e.g. of an infrared-transmissive material) may also be used in conjunction with such a detector to reduce interference from ambient illumination sources.

Alternatively, the transmitters, receivers, and/or transceivers of system 100 may be equipped as appropriate with one or more antennas for emitting and/or detecting communications signals. Depending upon design factors relating to the particular application (e.g. frequency band, desired range, form factor), such an antenna may be characterized as, for example, whip, coil, conformal, ring resonator, inverted-F, strip, and/or surface-mount and may be internal to the device or external.

The two-way wireless communications link with telephone 10 may be conducted over one or more optical and/or radio-frequency carriers, with information being transmitted and received via analog and/or digital modulation of these carriers. Communications between microphone 200 and speaker 300 (e.g. from transmitter 250 to receiver 360) may also be conducted over one or more optical and/or radio-frequency carriers, with information being transmitted and received via analog and/or digital modulation of these carriers.

Possible advantages of a digital modulation scheme include support for features such as transmission of information in packets. Transfer between system 100 and telephone 10 may be synchronous or asynchronous (for voice traffic, synchronous transmission is generally used). Coding schemes (e.g. speech codecs) may be used to reduce bandwidth (e.g. by reducing redundancy). Coding schemes (e.g. convolutional codes) may also be used to enable detection or even correction of errors in transmission (e.g. via forward error correction (FEC) coding).

Digital modulation may also be used in a spread spectrum transmission scheme. For example, a frequency hopping spread spectrum (FHSS) or a direct sequence spread spectrum (DSSS) scheme may be implemented. Another transmission schemes that may be used include frequency division multiplexing (FDM), which may also be used with analog modulation schemes, and time division multiplexing (TDM).

Device-level addressing may be implemented to allow more than one instance of system 100 to operate simultaneously in any given area and/or to allow system 100 to operate reliably and/or securely in the presence of other devices using the same frequency band. In one such addressing scheme, system 100 (or each of microphone 200 and speaker 300) is assigned an address and telephone 10 is assigned a different address (e.g. during manufacture, before or upon sale, or before or upon installation). Once each transmitter has obtained the address of its intended recipient, each transmission may be labeled for the specific recipient device, and other nearby devices will not be able to interpret the data which is transmitted. Such addressing schemes may provide a level of security and privacy to the user. Additional security schemes may also be employed which would allow the user to obtain additional privacy. For example, a key management or other encryption scheme may be utilized which could make it more difficult for a third party to listen in on a conversation or transmission.

Another technique that may be utilized to increase security is data scrambling (e.g. using a whitening sequence). With this type of technique, the data is initially scrambled (e.g. via an exclusive-OR operation with a given data sequence) before transmission, then unscrambled upon reception (e.g. via an exclusive-OR operation with the same given data sequence).

As discussed above, one or both directions of the two-way wireless communications link with telephone 10 may be maintained optically (e.g. via transmission and reception of modulated infrared light beams). In one class of implementations of system 100, the communications link with telephone 10 is compliant with a version of the IrDA DATA or CONTROL standards promulgated by the Infrared Data Association (IRDA) and/or a specification relating to one or more such standards (available at www.irda.org). Communications between microphone 200 and speaker 300 may also be maintained optically and may be compliant with one or more such standards and/or specifications.

Alternatively, the two-way wireless communications link with telephone 10 may be maintained via transmission and reception of modulated radio signals. In one class of implementations, the communications link with telephone 10 is compliant with a version of the Bluetooth specification (www.bluetooth.com). For example, system 100 (e.g. transceiver 260 or 350) may operate in compliance with a version of the Headset Profile (K6) or Hands-free Profile (e.g. revision 0.96) of such specification. In another class of implementations, the communications link with telephone 10 is compliant with at least one of the IEEE 802.11 standards for wireless communications such as 802.11a or 802.11b (http:H/standards.ieee.org, available for download at http://grouper.ieee.org/groups/802/11/) or a version of the upcoming 802.11 g standard (draft form available for download at http:/grouper.ieee.org/groups/802/11). Communications between microphone 200 and speaker 300 may be maintained in a similar fashion.

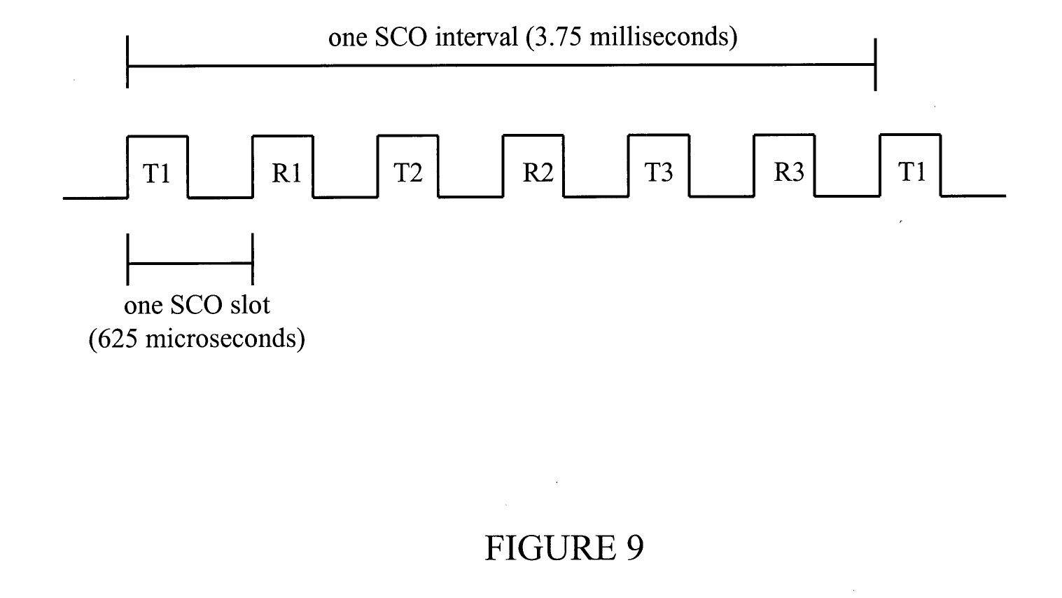

The Bluetooth specification provides for several different transmission schemes. Voice information is typically communicated using a Synchronous Connection-Oriented (SCO) scheme, while data traffic is typically communicated using an Asynchronous Connection-Less (ACL) scheme. FIG. 9 shows a timing diagram for a SCO scheme. Each SCO interval has six SCO slots: three transmit slots (T1, T2, T3) alternating with three corresponding receive slots (R1, R2, R3). A Bluetooth device may support up to three separate communications links under a SCO scheme.

Communications using an SCO scheme may be conducted using several different types of packets. The HV1 packet is transmitted three times in its interval (i.e. at every transmit slot), the HV2 packet is transmitted twice per interval, and the HV3 packet is transmitted once per interval. All of the HV packet types carry the same amount of voice information per interval (240 bits), but the HV3 packet uses no FEC coding on this information, while the HV1 and HV2 packets use ⅓ and ⅔ rate FEC coding, respectively. A hybrid packet type called DV may be used to carry a combination of data traffic and voice information. Empty slots in an SCO interval may also be used for data traffic under an ACL scheme.

The use of packets that use FEC coding may be desirable in a noisy environment, where noise generators may include automobile ignition systems as well as other electronic devices. For example, a Bluetooth system may be susceptible to interference from IEEE 802.11 devices that use the same unlicensed 2.4-GHz ISM (Industrial, Scientific, and Medical) frequency band.

In one implementation of system 100, microphone 100 (or speaker 200) may include a transceiver that communicates with telephone 10 using HV1 packets and communicates with speaker 200 (or microphone 100) using a non-Bluetooth scheme. Alternatively, the transceiver may communicate with telephone 10 using HV2 packets and communicate within system 100 using HV3 packets. In a further alternative, the transceiver may communicate with telephone 10 using HV3 packets and communicate within system 100 using HV2 or HV3 packets.

In another implementation of system 100, the transmit portion of the communications (e.g. Bluetooth) link is transmitted by microphone 200, and the receive portion of the link is received by speaker 300. Depending on the type of packets used by this link (e.g. how many Bluetooth slots remain available), microphone 200 and speaker 300 may use a Bluetooth or non-Bluetooth link to communicate control information with each other.

In a further implementation of system 100, microphone 100 and speaker 200 each include a transceiver having its own communications (e.g. Bluetooth) link with telephone 10, with the transceiver of microphone 200 providing the outgoing portion of a two-way voice communication and the transceiver of speaker 300 receiving the incoming portion of the communication.

In another implementation of system 100, microphone 200 includes a transceiver that supports a communications link with telephone 10. In this implementation, however, speaker 300 receives the incoming portion of the two-way voice communication directly from telephone 10 rather than from microphone 200 (e.g. by monitoring the communications link between telephone 10 and microphone 200).

In some such arrangements (e.g. for Bluetooth use), it may be desirable to configure speaker 300 with the ability to decode transmissions from telephone 10. Such configuration (or “authentication”) may include such tasks as decoding and storing a sequence of symbols transmitted by telephone 10 (e.g. during setup of the communications link with microphone 200). These tasks may be performed automatically: for example, when speaker 300 receives a signal of appropriate form (e.g. frequency or structure) and sufficient amplitude. For example, speaker 300 may automatically authenticate upon detecting a Bluetooth transmission from an unknown source (or only upon detecting such a transmission that conforms to a Handsfree or Headset profile). Alternatively, such configuration may occur in response to a user action (e.g. pushing a button provided on speaker 300 for this purpose).

In some such arrangements, speaker 300 may store authentication sequences for several different telephones 10, in which case speaker 300 may be configured to automatically apply the correct sequence upon detecting a communications link. Alternatively, such selection may be manually performed by a user. Storage of the sequences may be arranged such that only a few of the most recently stored unique sequences are retained (e.g. in a FIFO fashion).

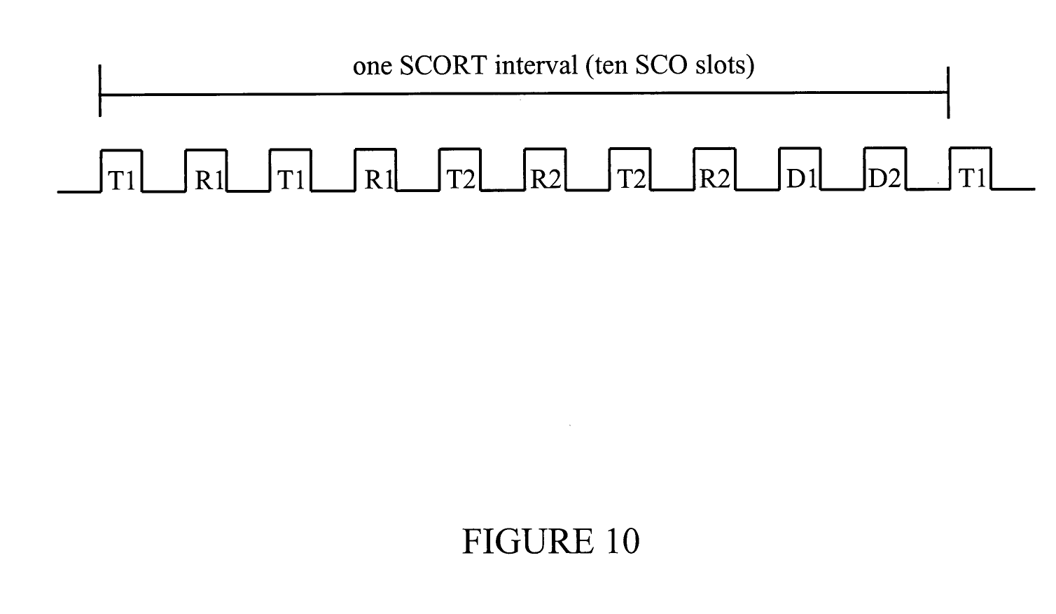

FIG. 10 shows a timing diagram for a proposed modification to the SCO scheme called SCORT (SCO with Repeated Transmission) (as described e.g. in IEEE P802.15 documents available at http://grouper.ieee.org). This scheme supports only one voice communications link, but each SCORT interval includes two slots available for data traffic (e.g. using an ACL scheme). In one implementation of system 100, microphone 200 includes a transceiver that supports a SCORT communications link with telephone 10. In this implementation, speaker 300 may receive the incoming portion of the two-way voice communication directly from telephone 10 (e.g. by monitoring the SCORT link) or from microphone 200 over a non-Bluetooth communications link.

A transmitter or transceiver as described herein receives voice and/or data information for transmission. The transmitter or transceiver may process this information (e.g. by applying processes such as equalization, filtering, encoding, etc.) and/or add additional information (such as identifiers of source, destination, or packet type) before transmission, as appropriate for the designed communications link with telephone 10. Likewise, a receiver or transceiver as described herein receives voice and/or data information for reproduction and/or for transfer to another device, circuit, or module, and the receiver or transceiver may process this information and/or separate it from other information before such reproduction or transfer.

In support of their various tasks, the elements of system 100 (e.g. receivers, transmitters, transceivers, and/or audio processors as described herein) may include control circuitry, analog signal processing circuitry, and/or digital signal processing circuitry. For example, such elements may include discrete components and/or integrated circuits (ICs, e.g. application-specific integrated circuits (ASICs)). More than one such element may be implemented in a single IC or ASIC, and a single element may be implemented in portions of more than one IC or ASIC. Such an IC or ASIC may include logic elements such as logic gates (e.g. for control or digital signal processing tasks) that may be programmable or otherwise configurable or upgradable. For example, the IC may be a field-programmable gate array (FPGA). Examples of manufacturers that produce ASICs for Bluetooth communications include, but are not limited to, AvantWave (Kowloon, Hong Kong), Microtune (Plano, TX), Cambridge Silicon Radio (makers of the BlueCore™ and BlueCore2™ chips; Cambridge, UK), and SiliconWave (San Diego, Calif.).

In addition to voice information, system 100 may transmit data to and/or receive data from telephone 10. For example, such data may include control information relating to such operations as, e.g., volume or mute control, call initiation or answering, and operations indicated via recognition of voice commands.

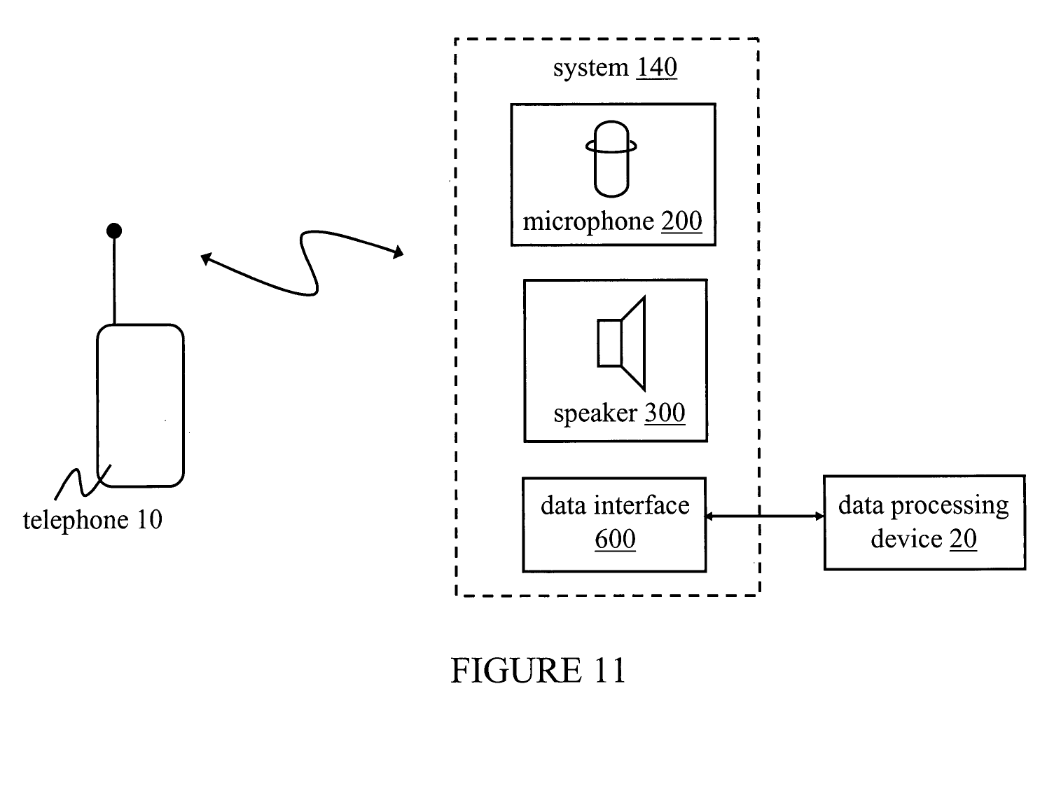

In a further implementation of system 100 as shown in FIG. 11, at least one of microphone 200 and speaker 300 includes a data interface 600 configured to be coupled conductively and/or optically to a data processing device 20 such as a computer (e.g. desktop or portable such as laptop or notebook) or PDA. Via interface 600, an implementation 140 of system 100 supports the transfer of data between data processing device 20 and an external computer or network via telephone 10.

In one application, a user may wish to provide electronic mail connectivity to data processing device 20. Using system 140, the user may gain access wirelessly to an e-mail server, a local network, or the Internet via telephone 10. The component of system 100 that includes data interface 600 may transmit data directly to telephone 10, or such data may be relayed through the other component of system 100.

Data interface 600 may be coupled to data processing device 20 in several different ways. For example, data interface 600 may include a Universal Serial Bus (USB) port. In some implementations, such a port may be used to provide system 100 not only with a data connection, but also with a power connection as described above.

The foregoing description has been provided to illustrate principles of the present invention and is not intended to be limiting. To the contrary, the invention is intended to encompass all alterations, additions, substitutions, and equivalents within the spirit and scope of the following appended claims. For example, the invention may be implemented in part or in whole as a hard-wired circuit, as a circuit configuration fabricated into an ASIC, or as a firmware program loaded into non-volatile storage or a software program loaded from or into a data storage medium as machine-readable code, such code being instructions executable by an array of logic elements such as a microprocessor, microcontroller, or other digital signal processing unit.

1. A wireless communications system configured to support a two-way voice communication with a telephone, said system comprising:
a microphone configured to receive a first audible signal and to transmit from a first location a first wireless signal including the outgoing portion of the two-way voice communication, said outgoing portion being based on the first audible signal; and
a speaker configured to receive at a second location a second wireless signal including the incoming portion of the two-way voice communication and to produce a second audible signal based on the incoming portion,
wherein the first location is separated from the second location.

2. The wireless communication system according to claim 1, at least one among the first wireless signal and the second wireless signal being compliant with a profile of the Bluetooth specification.

3. The wireless communication system according to claim 1, at least one among the first wireless signal and the second wireless signal including a carrier having a frequency within the range of two-and-four-tenths to two-and-one-half gigahertz.

4. The wireless communication system according to claim 1, wherein said microphone is configured to transmit the second wireless signal.

5. The wireless communication system according to claim 1, wherein said speaker is configured to transmit a third wireless signal including the outgoing portion of the two-way voice communication.

6. The wireless communication system according to claim 1, wherein said microphone and said speaker are physically separate from one another.

7. The wireless communication system according to claim 1, wherein said microphone and said speaker are locatable completely independently of one another.

8. The wireless communication system according to claim 1, wherein said microphone includes an analog-to-digital converter.

9. The wireless communication system according to claim 1, wherein said speaker includes a digital-to-analog converter.

10. The wireless communication system according to claim 1, at least one among said microphone and said speaker including a rechargeable power source.

11. The wireless communication system according to claim 1, at least one among said microphone and said speaker including a data interface configured to receive data from an external data processing device,
wherein said system is configured to transmit a wireless signal based on the data.

12. The wireless communication system according to claim 11, wherein the data interface is compliant with a version of the Universal Serial Bus specification.

13. A method of supporting a two-way voice communication with a telephone, said method comprising:
receiving a first audible signal and transmitting from a first location a first wireless signal including the outgoing portion of the two-way voice communication, said outgoing portion being based on the audible signal; and
receiving at a second location a second wireless signal including the incoming portion of the two-way voice communication and producing a second audible signal based on the incoming portion,
wherein the first location is separated from the second location.

14. The method according to claim 13, at least one among the first wireless signal and the second wireless signal being compliant with a profile of the Bluetooth specification.

15. The method according to claim 13, at least one among the first wireless signal and the second wireless signal including a carrier having a frequency within the range of two-and-four-tenths to two-and-one-half gigahertz.

16. The method according to claim 13, further comprising transmitting the second wireless signal from the first location.

17. The method according to claim 13, further comprising transmitting from the second location a third wireless signal including the outgoing portion of the two-way voice communication.

18. The method according to claim 13, wherein the first and second locations are independent of one another.

19. The method according to claim 13, wherein said receiving a first audible signal includes converting the first audible signal from analog to digital.

20. The method according to claim 13, wherein said producing a second audible signal includes converting the second audible signal from digital to analog.

21. The method according to claim 13, said method further comprising receiving data from an external data processing device and transmitting a wireless signal based on the data.

22. The method according to claim 21, wherein said receiving data includes receiving data via a data interface compliant with a version of the Universal Serial Bus specification.
